(19) United States
(12) Patent Application Publication
(10) Pub. No.: US 2003/0103196 A1
(43) Pub. Date: Jun. 5, 2003

(54) Exposure method and exposure apparatus

(75) Inventor: Shigeru Hirukawa, Kashiwa-shi (JP)

Correspondence Address: OLIFF & BERRIDGE, PLC, P.O. Box 19928, Alexandria, VA, 22320, US

(73) Assignee: NIKON CORPORATION

(21) Appl. No.: 10/290,197

(22) Filed: Nov. 8, 2002

Related U.S. Application Data
(63) Continuation of application No. 09/598,269, filed on Jun. 21, 2000, now abandoned.
Application No. 09/598,269 is a continuation of application No. PCT/JP98/05917, filed on Dec. 25, 1998.

(30) Foreign Application Priority Data
Dec. 26, 1997 (JP) 9-368230

(51) Int. Cl. G03B 27/52

(52) U.S. Cl. 355/55; 355/53; 355/77; 356/399; 356/400; 250/548

(57) ABSTRACT

An exposure method for forming on a wafer coated with a photo resist device patterns comprised of dense patterns and isolated patterns as components, including a first step of transferring first patterns comprised of dense patterns of shapes corresponding to the device patterns and dense patterns formed by patterns of shapes corresponding to the isolated patterns of the device patterns plus a plurality of auxiliary patterns on the wafer by ½ of the appropriate amount of exposure as determined by the sensitivity of the photo resist, and a second step of transferring second patterns comprised of dense patterns of shapes corresponding to the dense patterns of the device patterns and isolated patterns of shapes corresponding to the isolated patterns of the device patterns on the photosensitive substrate by ½ of the appropriate amount of exposure.

### BACKGROUND OF THE INVENTION

1. Field of the Invention

The present invention relates to an exposure method and exposure apparatus which is employed in the manufacture of microdevices such as semiconductor elements, thin-film magnetic heads, and liquid crystal display elements.

2. Description of the Related Art

In the photolithographic process, one of the processes for the manufacture of semiconductor elements, as an exposure apparatus for transferring a patterns formed on a mask or reticle (reticle patterns) to a photo resist, frequent use is made of a stepper for reducing and projecting the reticle patterns on shot areas of the wafer.

As steppers, the step-and-repeat type which repeatedly exposes the reticle patterns on one shot area of the reticle patterns at one time then moves the wafer and exposes another reticle patterns at one time and, recently, from the viewpoint of expanding the exposure range or improving the exposure performance, the step-and-scan type which repeatedly synchronously moves the mask and wafer for scanning and illumination by slit light of a rectangular or other shape to sequentially expose shot areas on the wafer, then successively moves the wafer for scan exposure of another shot area have been developed and put into commercial use.

In these types of exposure apparatuses, the illumination optical system illuminates the wafer coated with the photo resist through the mask formed with the reticle patterns by an appropriate amount of exposure in accordance with the sensitivity of the photo resist and thereby selectively photosensitizes the photo resist so as to form device patterns having shapes corresponding to the reticle patterns for one layer (latent images before development or patterns after development).

As the device patterns to be formed on a wafer, there are generally periodic patterns periodically repeating lines and spaces (L/S), dense patterns densely crowded with small distances between adjoining patterns, isolated patterns arranged relatively isolated from other patterns such as ones constituting peripheral circuit portions, and various other patterns mixed together.

In response to the demand for increasing miniaturization in recent years, effort has been made to shorten the wavelength of the light source or increase the numerical aperture of the projection optical system. In addition, high resolution technology has been developed for improving the resolution or depth of focus by the use of the phase shift method of providing a phase shifter at part of the mask for shifting the phase of light or annular illumination, small σ-illumination, modified illumination, etc. alone or in combination.

These high resolution technologies, however, differ in effectiveness depending on the pattern shape, line width, etc. For example, in the case of a dense patterns, light is diffracted from the mask to a specific discrete direction and lowers the resolution, so a combination of a phase shift reticle and small σ-illumination may be used reduce the breakdown of the pattern image due to defocus and obtain a large depth of focus. As opposed to this, in the case of isolated patterns, light is diffracted from the mask over a broad continuous range, so the effect of the high resolution technology is smaller compared to the dense patterns and a large depth of focus cannot be obtained.

Therefore, even if applying such high resolution technology, when simultaneously exposing and forming dense patterns and isolated patterns, the common depth of focus ends up becoming relatively small. Therefore it was difficult to handle the increasing miniaturization of patterns. Therefore, in the past, an exposure method for forming the device patterns by suitably partitioning the device patterns to be formed so as not to overlap and separately exposing the partitioned patterns by appropriate amounts of exposure in accordance with the sensitivity of the photosensitive substrate has been proposed (for example, see Japanese Unexamined Patent Publication (Kokai) No. 2-166717).

This method will be briefly explained with reference to FIG. 11A, FIG. 11B, and FIG. 1C. In these figures, the shaded portions show the light interrupting portions, while the non-shaded portions show the light transmitting portions. Note that in the following explanation, it is assumed that a positive resist is used as a photo resist and device patterns comprised of dense patterns 91c and isolated patterns 92c as shown in FIG. 11C are formed on the wafer coated with the photo resist.

First, as shown in FIG. 11A, a first reticle formed with reticle patterns comprised of dense patterns 91a of shapes corresponding to the dense patterns 91c of the device patterns and a light interrupting pattern 92a for protecting the portions formed with the isolated patterns 92c of the device patterns and their vicinity is used to expose the photo resist by an appropriate amount of exposure based on its sensitivity.

Next, as shown in FIG. 11B, a second reticle formed with a reticle pattern comprised of a light interrupting pattern 91b for protecting the portions corresponding to the dense patterns 91c of the device patterns and their vicinity and an isolated pattern 92b of a shape corresponding to the isolated pattern 92c of the device patterns is used to expose the photo resist by an appropriate amount of exposure as determined by its sensitivity. By this, the same region on the photo resist is exposed twice.

By partitioning the device patterns to be formed into dense patterns 91c and isolated patterns 92c in this way, providing a reticle formed with reticle patterns having the corresponding dense patterns 91a and another reticle formed with reticle patterns having the corresponding isolated patterns 92b, and using high resolution technology suited to formation of these patterns for separately transferring and forming the patterns, it is possible to achieve an high resolution overall.

Here, when exposing and forming fine patterns, the line widths of the patterns change due to various error such as a change of focus, change of amount of exposure, synchronization accuracy of the stages, etc. These errors may be roughly divided into systematic error occurring repeatedly with exhibiting a particular trend and random error occurring randomly without exhibiting any particular trend. Elimination of such error by some method or another would be advantageous in improving the accuracy and increasing the fineness of the device patterns formed.

While some of above conventional exposure methods proposed double exposure by appropriate amounts of exposure as determined by the sensitivity of the photo resist, the dense patterns and isolated patterns of the device patterns formed were formed by substantially a single exposure. Therefore, there was no difference at all in terms of the reduction of the random error from the usual exposure method of forming device patterns by a single exposure and deterioration of the pattern shape due to random error could not be prevented.

Further, since they substantially performed exposure a single time, there was the problem that focus error, a type of systematic error stemming from the unevenness of the wafer surface and the positional dependency of the focus, caused the defocus portions to become thinner or thicker with a certain trend based on the pattern shapes etc. and thereby preventing achievement of appropriate and regular line widths. This was a particular problem for isolated patterns where there is a remarkable tendency for the line widths to become thinner due to defocus.

Further, since they performed exposure twice by the appropriate amount of exposure as determined by the sensitivity of the photo resist, twice the amount of exposure compared with formation of device patterns by a single exposure was necessary, a longer time was required for processing, and the cost of the laser or other light source could not be reduced.

### SUMMARY OF THE INVENTION

Accordingly, an object of the present invention is to reduce the random error at the time of exposure and form fine patterns with a good accuracy.

Another object of the present invention is to reduce the changes in line widths of device patterns due to defocus and realize line widths close to the line widths in the case of exposure by the best focus for all patterns.

A still other object of the present invention is to improve the processing speed of exposure and reduce the costs.

1. To achieve the above objects, according to the present invention, there is provided an exposure method for forming device patterns on a photosensitive substrate, comprising overlaying and transferring a plurality of patterns on the photosensitive substrate by an amount of exposure less than the appropriate amount of exposure as determined by the sensitivity of the photosensitive substrate to form the device patterns.

Since the method of the present invention overlays and transfers the plurality of patterns by an amount of exposure smaller than the appropriate amount of exposure as determined by the sensitivity of the photosensitive substrate, the random error occurring randomly without exhibiting any particular trend can be reduced by an averaging effect and therefore the exposure accuracy can be improved and fine patterns can be formed with a good accuracy.

The method of the present invention is effective in improving the exposure accuracy of patterns of all types of shapes and for example can overlay and transfer a plurality of periodic patterns of substantially the same shapes as the device patterns to be formed.

Further, it is possible to overlay and transfer a plurality of isolated patterns of substantially the same shapes as the device patterns to be formed. In this case in particular, it is possible to add auxiliary patterns to at least one isolated pattern to transfer it as a dense pattern. By doing this, it becomes possible to form isolated patterns using high resolution technology effective for transfer of dense patterns.

Further, since each exposure among the plurality of exposures is performed by an amount of exposure smaller than the appropriate amount of exposure as determined by the sensitivity of the photosensitive substrate, it is not necessarily essential to set the line widths of the auxiliary patterns in consideration of the resolution limit as in the case of forming device patterns by adding auxiliary patterns and performing exposure a single time by the appropriate amount of exposure. There are few restrictions on the line width, shape, arrangement, etc. of the auxiliary patterns. It is therefore possible to handle the high resolution technology in use relatively flexibly in terms of compatibility.

Further, since each exposure among the plurality of exposures is performed by an amount of exposure smaller than the appropriate amount of exposure as determined by the sensitivity of the photosensitive substrate, it becomes possible to partition the device patterns to be formed on the photosensitive substrate so as not to overlap, increase the processing speed compared with the conventional exposure method of exposing each of the partitioned patterns by the appropriate amount of exposure, use a relatively low output light source, and reduce the hardware costs.

2. To achieve the above objects, according to the present invention, there is provided an exposure method for forming device patterns on a photosensitive substrate, comprising transferring on to the photosensitive substrate first and second patterns having substantially the same shapes as the device patterns so that said patterns of the same shape are overlaid to form the device patterns.

In the present invention, since first and second patterns having patterns of the same shapes as the device patterns are transferred on to the photosensitive substrate so that patterns of the same shapes are overlaid, the random error of the overlaid portions is reduced by the averaging effect and, therefore, the exposure accuracy can be improved and fine patterns can be formed with a good accuracy.

The method of the present invention is effective in improving the exposure accuracy of patterns of all types of shapes and can make the first and second patterns having dense patterns of substantially the same shapes as the device patterns to be formed.

Further, it is possible to make the first and second patterns having isolated patterns and add auxiliary patterns to at least one of the first and second patterns. This makes it becomes possible to form isolated patterns with a good accuracy by using high resolution technology effective for transfer of dense patterns.

Note that the exposure conditions in the transfer of the first patterns and the transfer of the second patterns are not particularly limited and may be the same or different. The amounts of exposure, however, may be set so that the sum of the amounts of exposure given to the photosensitive substrate at the time of transfer of the first and second patterns becomes the appropriate amount of exposure as determined by the sensitivity of the photosensitive substrate. In this case, the amounts of exposure at the time of transfer of the first and second patterns may be set to be become substantially equal.

Further, when the densities of the first and second patterns differ, it is possible to make the exposure conditions of the photosensitive substrate different between the first patterns and second patterns. As the exposure conditions in this case, it is possible to use ones including illumination conditions of the first and second patterns.

3. To achieve the above objects, according to the present invention, there is provided an exposure method for forming device patterns on a photosensitive substrate through a projection optical system, comprising a step of overlaying and transferring on the photosensitive substrate first and second patterns having changes in line widths of pattern images due to positions in a direction of the optical axis of the projection optical system of opposite trends to form said device patterns.

For example, when the surface of the photosensitive substrate is uneven, the portions present at the best focus position of the patterns being transferred become the appropriate line widths if the random error can be ignored, but the line widths of the portions not at the best focus position, that is, present at defocus positions, become narrower or thicker depending on the amount of offset (amount of defocus) from the focal plane in the direction of the optical axis of the projection optical system, so do not become the appropriate line widths.

By employing the method of the present invention, this point is improved. That is, the first patterns and the second patterns are patterns exhibiting opposite trends in the changes in line widths of the pattern images as determined by the position in the direction of the optical axis of the projection optical system. Since these are overlaid for transfer, by having the line widths at the defocus portions of the transferred patterns be formed thicker or thinner due to the defocus at the time of transfer of the first patterns and be formed exhibiting an opposite trend due to the same defocus at the time of transfer of the second patterns, these cancel each other out to give line widths close to the line widths at the best focus position and therefore the changes in line widths of device patterns accompanying changes in focus can be reduced.

More specifically, when the photosensitive substrate is offset from the focal plane of the projection optical system, it is possible to overlay and transfer on to the photosensitive substrate first patterns where the line widths of the pattern images formed on the photosensitive substrate become thinner than the device patterns and a second pattern where the line widths of the pattern images formed on the photosensitive substrate become thicker than the device patterns.

More specifically, when the device patterns to be formed are isolated patterns, the first patterns may be made isolated patterns and the second patterns may be made dense patterns to be partially overlaid on the isolated patterns. According to research by the present inventors etc., when the exposure conditions are the same, isolated patterns tend to become thinner in line width due to defocus, while dense patterns tend to become thicker in line width. By overlaying these, it is possible to form isolated patterns close to the appropriate line widths.

Note that the patterns other than isolated patterns overlaid with the first patterns among the second patterns serving as the dense patterns in this case are auxiliary patterns not contributing to the formation of device patterns.

Further, the exposure conditions in the transfer of the first patterns and the transfer of the second patterns are not particularly limited and may be the same or different. The amounts of exposure, however, may be set so that the sum of the amounts of exposure given to the photosensitive substrate at the time of transfer of the first and second patterns becomes the appropriate amount of exposure as determined by the sensitivity of the photosensitive substrate. In this case, the amounts of exposure at the time of transfer of the first and second patterns may be set to be become substantially equal.

Further, when the densities of the first and second patterns differ, it is possible to make the exposure conditions of the photosensitive substrate different between the first pattern and second pattern. As the exposure conditions in this case, it is possible to use ones including illumination conditions of the first and second patterns.

4. To achieve the above objects, according to the present invention, there is provided an exposure apparatus for forming device patterns on a photosensitive substrate through a projection optical system, comprising a holder for arranging first and second patterns at an object plane of said projection optical system so that first and second patterns, including patterns of the same shapes as the device patterns, are selectively projected on the photosensitive substrate and a position adjuster for adjusting the relative positions of the projected images of the first and second patterns with the photosensitive substrate so that patterns of the same shapes are overlaid and transferred on the photosensitive substrate.

The projection exposure apparatus of the present invention is an apparatus for working the method of the present invention. First, the holder arranges one of the first and second patterns at the object plane side of the projection optical system, the position adjuster adjusts the relative positions of the projected images of one of the first and second patterns with the photosensitive substrate, then, or during this, transfer and exposure are performed. Next, the holder arranges the other of the first and second patterns at the object plane side of the projection optical system, the position adjuster adjusts the relative positions of the projected image of the other of the first and second patterns with the photosensitive substrate, then, or during this, transfer and exposure are performed, whereby the overlaid portions having the same shapes in the projected images of the first and second patterns become the device pattern.

The overlaid portions having the same shape in the transferred images of the first and second patterns are reduced in random error due to the averaging effect resulting from the two exposures and are improved in the accuracy of the shapes including the line widths of the device patterns. Further, the portions other than the overlaid portions of the same shape in the transferred images of the first and second patterns (auxiliary patterns) receive a small amount of exposure compared with the portions having the same shape and do not contribute to the development, so the auxiliary patterns can be freely formed in shape or line width. Fine patterns can be formed by suitable selection from the viewpoint of the trends in the change in line width due to defocus.

### BRIEF DESCRIPTION OF THE DRAWINGS

FIG. 1 is a view of the overall, schematic configuration of an exposure apparatus of the present invention;

FIG. 2A is a view of first reticle patterns of a first embodiment of the present invention;

FIG. 2B is a view of second reticle patterns of the first embodiment of the present invention;

FIG. 2C is a view of the shapes of device patterns of the first embodiment of the present invention;

FIG. 3 is a view of changes in pattern line widths due to the amount of defocus of the first embodiment of the present invention;

FIG. 4A is a view of the shapes of first reticle patterns of a second embodiment of the present invention;

FIG. 4B is a view of the shapes of second reticle patterns of the second embodiment of the present invention;

FIG. 4C is a view of the shapes of device patterns of the second embodiment of the present invention;

FIG. 5A is a view of the shapes of first reticle patterns of a third embodiment of the present invention;

FIG. 5B is a view of the shapes of second reticle patterns of the third embodiment of the present invention;

FIG. 5C is a view of the shapes of device patterns of the third embodiment of the present invention;

FIG. 6A is a view of the shapes of first reticle patterns of a fourth embodiment of the present invention;

FIG. 6B is a view of the shapes of second reticle patterns of the fourth embodiment of the present invention;

FIG. 6C is a view of the shapes of device patterns of the fourth embodiment of the present invention;

FIG. 7A is a view of image intensity distribution on a wafer in the case of exposure using the patterns of FIG. 6A;

FIG. 7B is a view of image intensity distribution on a wafer in the case of exposure using the patterns of FIG. 6B;

FIG. 7C is a view of image intensity distribution on a wafer in the case of overlay exposure using the patterns of FIG. 6A and FIG. 6B;

FIG. 8A is a view of the shapes of first reticle patterns of a fifth embodiment of the present invention;

FIG. 8B is a view of the shapes of second reticle patterns of the fifth embodiment of the present invention;

FIG. 8C is a view of the shapes of device patterns of the fifth embodiment of the present invention;

FIG. 9A is a view of image intensity distribution on a wafer in the case of exposure using the patterns of FIG. 8A;

FIG. 9B is a view of image intensity distribution on a wafer in the case of exposure using the patterns of FIG. 8B;

FIG. 9C is a view of image intensity distribution on a wafer in the case of overlay exposure using the patterns of FIG. 8A and FIG. 8B;

FIG. 10A is a view of the shapes of first reticle patterns of a sixth embodiment of the present invention;

FIG. 10B is a view of the shapes of second reticle patterns of the sixth embodiment of the present invention;

FIG. 10C is a view of the shapes of device patterns of a sixth embodiment of the present invention;

FIG. 11A is a view of the shapes of first reticle patterns of the related art;

FIG. 11B is a view of the shapes of second reticle patterns of the related art; and

FIG. 11C is a view of the shapes of the device patterns of the related art.

### DESCRIPTION OF THE PREFERRED EMBODIMENTS

An explanation will be given next with reference to the attached drawings to explain the present invention in further detail.

[Overall Configuration]

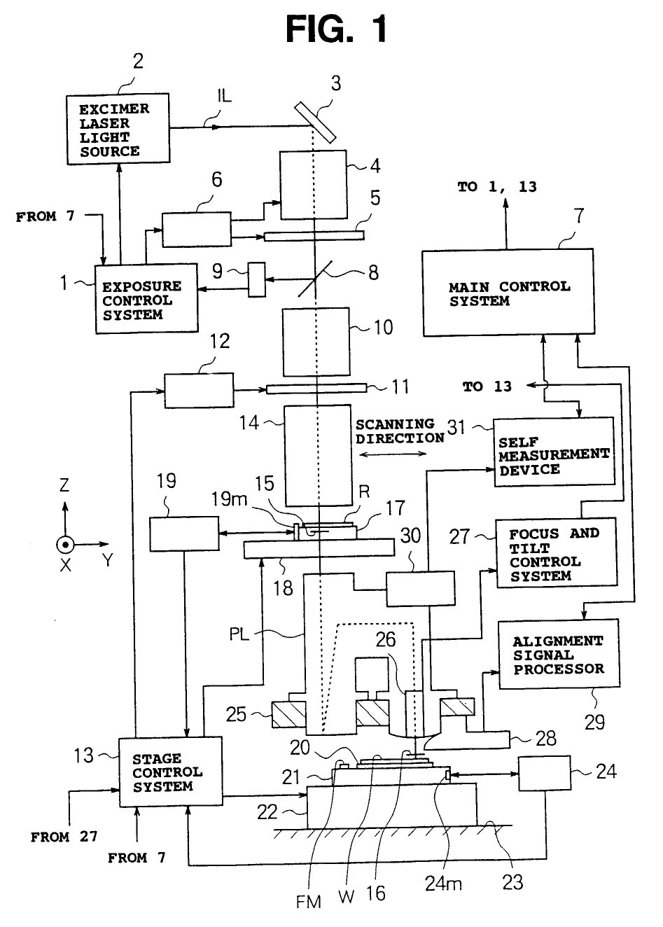

First, an explanation will be given of the overall configuration of a projection exposure apparatus of the embodiments of the present invention with reference to FIG. 1. FIG. 1 shows the schematic configuration of a projection exposure apparatus of the step-and-scan type using a reflection and refraction system as a projection optical system.

In FIG. 1, illumination light IL comprised of pulse laser light emitted from an excimer laser light source 2 controlled in state of emission by an exposure control system 1 is deflected at a deflection mirror 3 and reaches a first illumination system 4. In the present example using an excimer laser light source 2, use is made of a natural oscillation laser not having a device for narrowing the wavelength band, that is, a band broadening laser light source of an KrF excimer laser having a half width of the oscillation spectrum of more than 100 pm (wavelength 248 nm). As the light source for exposure, however, it is possible to use a band broadening laser light source of an ArF excimer laser (wavelength 193 nm) or F₂ laser (wavelength 157 nm) or possible to use a metal vapor laser light source, YAG laser harmonic generator, or emission line lamp such as mercury lamp, etc.

Note that the projection optical system PL of the present embodiment is a reflection and refraction optical system (catadioptric system) combining a plurality of reflection optical elements including concave mirrors having reflection surfaces made aspherical and other mirrors and refraction optical elements such as lenses, but it may also be a projection optical system comprised of only a plurality of refraction optical elements. In this case, the exposure illumination light is narrowed to a wavelength band (half band) of for example 1 to 3 pm.

The first illumination system 4 includes a beam expander, variable light mechanism, illumination switching mechanism for switching the quantity of the illumination light when changing the coherence factor (so-called σ-value) of the illumination optical system, optical integrator (rod integrator or fly-eye lens), etc. Further, at the emission plane of the first illumination system 4 is formed a secondary light source for distributing the illumination light IL planarly. At the plane of formation of the secondary light source is arranged a switch revolver 5 for illumination system aperture stops for switching among various illumination conditions. At the side surface of the switch revolver 5 are formed the ordinary circular aperture stop, a so-called modified illumination aperture stop comprised of a plurality of apertures offset from the optical axis, an annular shaped aperture stop, and a small σ-value aperture stop comprised of a small circular aperture. Further, when switching the aperture stop of the illumination system, the illumination switching mechanism of the first illumination system 4 is switched so that the quantity of light becomes largest in synchronization with the switch 6.

The operation of the switch 6 is controlled by the exposure control system 1, while the operation of the exposure control system 1 is controlled by a main control system 7 for overall control of the operation of the apparatus.

Here, a planar light source (above secondary light source) comprised of a plurality of light source images is formed at the emission side focal plane of the fly-eye lens serving as the emission plane of the first illumination system 4. Further, the fly-eye lens is arranged at the surface (pupil plane) which has an emission side focal plane which is in a Fourier transform relation with the pattern surface of the reticle R (object plane of projection optical system PL) in the illumination optical system (4, 10, 14, etc.). Therefore, by changing the aperture stop by the switch 6, it becomes possible to change at least one of the shape and size of the secondary light source, that is, the intensity distribution of the illumination light IL on the Fourier transform plane (pupil plane) in the illumination optical system, in accordance with the pattern of the reticle R. Note that the Fourier transform plane in the illumination optical system is conjugate with the Fourier transform plane (pupil plane) of the pattern plane of the reticle R in the projection optical system PL. In the present example, the image of the secondary light source is formed on the Fourier transform plane in the projection optical system PL for so-called Keller illumination.

The illumination light IL passing through the illumination system aperture stop set by the switch revolver 5 strikes the beam splitter 8 with the large transmittance and small reflectance. The illumination light reflected at the beam splitter 8 is received at the integrator sensor 9 formed by a photo diode or other photoelectric sensor. The detection signal obtained by photoelectric conversion of the illumination light at the integrator sensor 9 is supplied to the exposure control system 1. The relation between the detection signal and the amount of exposure on the wafer is measured and stored in advance. The exposure control system 1 monitors the cumulative amount of exposure on the wafer by the detection signal. The detection signal is used for normalizing the output signals of the various sensors using the exposure illumination light IL.

The illumination light IL passing through the beam splitter 8 illuminates the illumination field stop system (reticle blind system) 11 through the second illumination system 10. The plane of arrangement of the illumination field stop system 11 is conjugate with the incidence plane of the fly-eye lens in the first illumination system 4. The illumination field stop system 11 is illuminated by an illuminated area similar in sectional shape with the lens elements of the fly-eye lens. The illumination field stop system 11 is divided into a movable blind and fixed blind. The fixed blind is comprised of a fixed field stop having a rectangular aperture, while the movable blind is comprised of two pairs of movable blades movable in the scan direction and non-scan direction of the reticle. The shape and size (width) of the illuminated area on the reticle are determined by the fixed blind. The movable blind is operated to gradually open and operated to gradually close the aperture of the fixed blind at the start and end of the scan exposure. This prevents the illumination light from striking the regions other than the shot areas to be inherently exposed. Note that a specific configuration of the illumination field stop system 11 is disclosed in U.S. Pat. No. 5,473,410. The disclosure of that U.S. patent is adopted as part of the description of this specification in so far as the domestic laws of the country designated or country elected by this international application allow.

The operation of the movable blind in the illumination field stop system 11 is controlled by the drive 12. When synchronously scanning the reticle and wafer as explained later by a stage control system 13, the stage control system 13 synchronously drives the movable blind in the scan direction through the drive 12. The illumination light IL passing through the illumination field stop system 11 passes through a third illumination system 14 to illuminate the rectangular illuminated area 15 of the pattern surface (lower surface) of the reticle R by a uniform illumination distribution. The plane of arrangement of the movable blind of the illumination field stop system 11 is conjugate with the pattern surface of the reticle R. The fixed blind is arranged away from the conjugate plane in the direction of the optical axis (is defocused). The shape of the illuminated area 15 is defined by the aperture of the fixed blind.

Below, the explanation will be given taking the X-axis in the plane parallel to the pattern surface of the reticle R and perpendicular to the paper surface of FIG. 1 and the Z-axis perpendicular to the pattern surface of the reticle R. At this time, the illuminated area 15 on the reticle R is a rectangular region long in the X-direction. At the time of scan exposure, the reticle R is scanned with respect to the illuminated area 15 in the +Y direction or −Y direction. That is, the scan direction is set to the Y-direction.

The pattern in the illuminated area 15 on the reticle R is reduced by a projection magnification β (βis for example ¼, ⅕, etc.) through a double-sided (or one side at wafer side) telecentric projection optical system PL and focused and projected on the exposure region 16 of the wafer W surface coated with the photo resist. The projection optical system PL has a circular field. The pattern surface of the reticle R is arranged at a first plane (object plane), while the exposure surface of the wafer W (for example, the front surface) is arranged at a second plane (imaging plane). Further, the illuminated area of the illumination light IL is defined as a rectangular shape (slit shape) extending along a direction (X-direction) perpendicular to the scan direction (Y-direction) of the reticle R and wafer W in the circular field of the projection optical system PL by the illumination field stop system 11 (fixed blind). Note that the specific configuration of the projection optical system PL of FIG. 1 is for example disclosed in Japanese Unexamined Patent Publication (Kokai) No. 9-246140 (and the corresponding U.S. patent application Ser. No. 08/813,968 filed on Mar. 3, 1997). The disclosures of that Japanese publication and U.S. patent are adopted as part of the description of this specification in so far as the domestic laws of the country designated or country elected by this international application allow.

The reticle R is held on the reticle stage 17. The reticle stage 17 is carried via an air bearing on a guide extending in the Y-direction on the reticle support 18. The reticle stage 17 can scan over the reticle support 18 through the linear motor in the Y-direction at a constant speed and is provided with an adjustment mechanism which can adjust the position of the reticle R in the X-direction, Y-direction, and rotation direction (θ direction). A moving mirror 19m fixed to an end of the reticle stage 17 and laser interferometers (not shown except for Y-axis) 19 fixed to a not shown column are used to measure the positions of the reticle stage 17 (reticle R) in the X-direction and Y-direction by a resolving power of about 0.001 μm at all times. The rotational angle of the reticle stage 17 is also measured, the measured values are supplied to the stage control system 13, and the stage control system 13 controls the operation of the linear motor etc. on the reticle support 18 in accordance with the measured values supplied.

On the other hand, the wafer W is held on a wafer table 21 through a wafer holder 20. The wafer table 21 is placed on a wafer stage 22, while the wafer stage 22 is placed on a guide of the platen 23 through an air bearing. Further, the wafer stage 22 is designed to be able to scan and step on the platen 23 at a constant speed by a linear motor in the Y-direction and to step in the X-direction. Further, the wafer stage 22 has built into it a Z-stage mechanism moving the wafer table 21 in a predetermined range in the Z-direction and a tilt mechanism (leveling mechanism) adjusting the tilt angle of the wafer table 21.

The moving mirror 24m fixed to an end of the wafer table 21 and laser interferometers (not shown except for Y-axis) 24 fixed to a not shown column are used to measure the positions of the wafer table 21 (wafer W) in the X-direction and Y-direction by a resolving power of about 0.001 μm at all times. The rotational angle of the wafer stage 21 is also measured. The measured values are supplied to the stage control system 13, and the stage control system 13 controls the operation of the linear motor etc. for driving the wafer stage 22 in accordance with the measured values supplied.

At the time of scan exposure, the main control system 7 sends the stage control system 13 an exposure start command. In response to this, the stage control system 13 makes the wafer W engage in a scan motion in the Y-direction at a speed Vw through the wafer stage 22 in synchronization with the scan motion of the reticle R in the Y-direction though the reticle stage 17. The scan speed Vw of the wafer W is set to β·V2 using the projection magnification β from the reticle R to the wafer W.

Further, the projection optical system PL is held in the upper plate of the U-shaped column 25 projecting from the base plate 23. It projects a slit image etc. at an angle to the plurality of measurement points of the surface of the wafer W at the side part in the X-direction of the projection optical system PL and outputs a plurality of focus signals corresponding to positions of the plurality of measurement points in the Z-direction (focus position). An oblique incidence type multi-point autofocus sensor (hereinafter called an “AF sensor”) 26 is provided. The plurality of focus signals from the multi-point AF sensor 26 are supplied to a focus tilt control system 27. The focus tilt control system 27 finds the focus position and inclination angle of the surface of the wafer W from the plurality of focus signals and supplies the results found to the stage control system 13. Note that the specific configuration of the multi-point AF sensor 26 is disclosed in Japanese Unexamined Patent Publication (Kokai) No. 6-283403 and its corresponding U.S. Pat. No. 5,448,332. The disclosures of that Japanese publication and U.S. patent are adopted as part of the description of this specification in so far as the domestic laws of the country designated or country elected by this international application allow.

The stage control system 13 drives the Z-stage mechanism and tilt mechanism in the wafer stage 22 so that the supplied focus position and inclination angle match with the focus position and inclination angle of the imaging plane of the projection optical system PL found in advance. Due to this, even during scan exposure, the surface of the exposure region 16 of the wafer W is controlled to match with the imaging plane of the projection optical system by the auto focus system and auto leveling system.

Further, an off-axis system alignment sensor 28 is fixed to the side surface of the +Y direction of the projection optical system PL. At the time of alignment, the alignment sensor 28 detects the positions of alignment marks attached to the shot areas of the wafer W and supplies the detection signal to the alignment signal processor 29. The alignment signal processor 29 is supplied with the measurement values of the laser interferometers 24. The alignment signal processor 29 calculates the coordinates in the stage coordinate system (X,Y) of a wafer mark detected from the detection signal and measurement values of the laser interferometers and supplies them to the main control system 7. The stage coordinate system (X,Y) means the coordinate system determined by the X-coordinate and Y-coordinate of the wafer table 21 measured by the laser interferometers 24. The main control system 7 finds the coordinates of the shot areas on the wafer W by the stage coordinate system (X,Y) from the coordinates of the supplied wafer mark and supplies them to the stage control system 13. The stage control system 13 controls the position of the wafer stage 22 at the time of scan exposure of the shot areas based on the coordinates supplied.

Further, a fiducial mark member FM is affixed to the wafer table 21. Various fiducial marks serving as the positional reference of the alignment sensors and reference reflection surfaces serving as reference for the reflection rate of the wafer W are formed on the surface of the fiducial mark member FM. Further, a reflection light detecting system 30 detecting flux etc. reflected from the wafer W side through the projection optical system PL is attached to the top end of the projection optical system PL. The detection signal of the reflection light detection system 30 is supplied to an self measurement device 31. Under the control of the main control system 7, the self measurement device 31 monitors the amount of reflectance (reflection rate) of the wafer W, measures the illumination evenness, measures the spatial image, etc.

The reticle stage 17 in this embodiment may simultaneously fix and hold a plurality of reticles R (first reticle R1 and second reticle R2). Under the control of the stage control system 13, it positions one reticle among the plurality of reticles R1 and R2 selectively at a predetermined illumination position (initial position of scan). In this state, scan exposure is performed by the emission of pulse laser light at a suitable oscillation frequency from the excimer laser light source 2 under the control of the exposure control system 1 in relation with the field (aperture width) due to the illumination field stop system 11 and the sensitivity of the photo resist etc. and by the relative movement of the wafer W and reticle R at a suitable speed under the control of the stage control system 13 so that the substantive amount of exposure on the wafer W becomes the appropriate amount of exposure.

Note that the above projection exposure apparatus is a step-and-scan type, but the exposure apparatus to which the present invention is applied is not limited to the above exposure apparatus and may also be applied to a step-and-repeat type projection exposure apparatus or a mirror protection aligner etc. Further, the invention may be also applied to a reduction projection type scan exposure apparatus using as a light source an SOR generating EUV (extreme ultraviolet) light having an oscillation spectrum in the soft X-ray region (wavelength 5 to 15 nm or so), for example, 13.4 nm or 11.5 nm or a laser plasma light source or an X-ray scan exposure apparatus of the proximity type.

[First Embodiment (Formation of Dense Patterns and Isolated Patterns)]

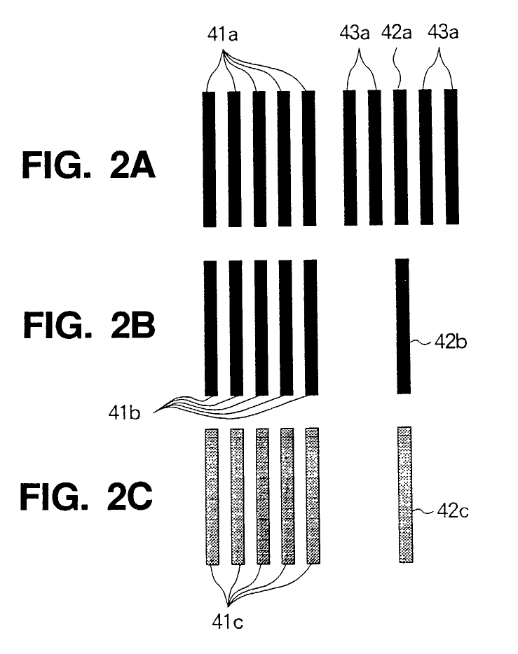

An explanation will given first of the case of forming dense patterns and isolated patterns having periodicity as device patterns with reference to FIG. 2A, FIG. 2B, and FIG. 2C. Note that FIG. 2A and FIG. 2B show reticle patterns formed on the reticle. The shaded portions show light interrupting portions, while the non-shaded portions show the light transmitting portions. FIG. 2C shows the device patterns to be formed or formed on the wafer W. The shaded portions show lines (projections), while the non-shaded portions show spaces (depressions).

Assume that device patterns comprised of the dense patterns 41c and isolated patterns 42c as shown in FIG. 2C as components are formed on a wafer W coated with a photo resist (positive resist) having a predetermined sensitivity.

In this case, a first reticle R1 and second reticle R2 formed with the following reticle patterns are prepared. That is, as shown in FIG. 2A, the first reticle R1 is formed with reticle patterns comprised of dense patterns 41a of shapes corresponding to the dense patterns 41c of the device patterns and dense patterns similar to the dense patterns 41a formed by patterns 42a of shapes corresponding to the isolated patterns 42c of the device patterns plus a plurality of auxiliary patterns 43a in their vicinity.

The second reticle R2, as shown in FIG. 2B, is formed with reticle patterns comprised of dense patterns 41b of shapes corresponding to the dense patterns 41c of the device patterns and isolated patterns 42b of shapes corresponding to the isolated patterns 42c of the device patterns. The first reticle R1 and the second reticle R2 are fixed and held on the reticle stage 17. Note that in this example, the dense patterns 41a and 41b and the isolated patterns 42a and 42b are formed by the same conditions respectively (line width, pitch, duty, etc.) Further, the isolated patterns 42a and auxiliary patterns 43a comprise line-and-space patterns having a pitch of twice the line width of the isolated patterns 42a and a duty ratio of 1:1.

First, the stage control system 13 controls the reticle position adjustment mechanism etc. of the reticle stage 17 to set the first reticle R1 at a predetermined illumination position (initial position of scan start) and determines the number of exposure pulses of the illumination light IL to be irradiated at each point in the exposure region on the wafer W (photo resist) to which the pattern of the first reticle R1 is to be transferred so as to give a substantial amount of exposure at the wafer W of ½ of the appropriate amount of exposure as determined by the sensitivity of the photo resist coated on the wafer W. The number of exposure pulses is preferably set to at least the minimum number of pulses required for the cumulative amount of exposure at the points in the exposure region to become substantially equal, that is, the cumulative distribution of light on the exposure region to become substantially uniform and so that the cumulative amount of light substantially matches with ½ of the appropriate amount of exposure, that is, the control accuracy of the cumulative amount of light becomes less than a predetermined allowable value. Note that before determining the number of exposure pulses, one of the plurality of aperture stops (for example, the annular shaped aperture stop) on the switch revolver, selected in accordance with the patterns of the first reticle R1, is arranged in the optical path of illumination and the intensity of the illumination light IL emitted from the selected aperture stop is detected by the integrator sensor 9.

Further, the average intensity of the illumination light IL is determined based on the number of exposure pulses and the appropriate amount of exposure (in the example, ½ of the same) and the variable light mechanism in the first illumination system 4 is adjusted in accordance with the average intensity. The variable light mechanism has a turret plate with a plurality of ND filters affixed with different transmittances (attenuation rates). One ND filter selected in accordance with the previously determined average intensity is arranged in the optical path of illumination. Note that the specific configuration etc. of the variable light mechanism are disclosed for example in Japanese Unexamined Patent Publication (Kokai) No. 6-252022 and the corresponding U.S. Pat. No. 5,627,627. The disclosures of that Japanese publication and U.S. patent are adopted as part of the description of this specification in so far as the domestic laws of the country designated or country elected by this international application allow. Further, in the present example, the exposure control system 1 controls the voltage applied to the excimer laser light source 2 (charging voltage) to enable adjustment of the oscillation intensity of the illumination light IL and enable fine adjustment of the intensity of the illumination light IL by use with the variable light mechanism over a broad range.

Next, the main control system 7 suitably adjusts one or both of the oscillation frequency of the laser light by the excimer laser light source 2 and the movement speed of the wafer stage 22 in relation with the intensity (mean value) of the excimer laser for the first scan exposure.

Next, the stage control system 13 controls the reticle position adjustment mechanism etc. of the reticle stage 17 to set the second reticle R2 at a predetermined illumination position and perform a second scan exposure so as to give a substantial amount of exposure at the wafer W of ½ of the appropriate amount of exposure as determined by the sensitivity of the photo resist coated on the wafer W in the same way as above. This forms the device patterns 41c and 42c given the appropriate amount of exposure by the two exposures on the wafer W. Note that the images transferred by the auxiliary patterns 43a are exposed by ½ of the appropriate amount of exposure, so do not remain after development.

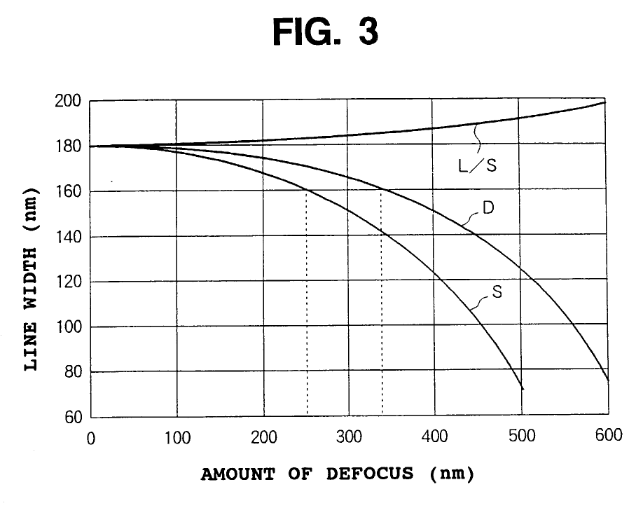

FIG. 3 is a view of the relation between the amount of defocus and the pattern line width (dependency of pattern line width on focus). The figure shows the result of simulation of a spatial image in the case of using a KrF excimer laser of a wavelength of 248 nm as the light source, using an annular illumination optical system of a numerical aperture NA of 0.60, a σ-value of 0.75, and an annular ratio of ⅔, and forming L/S lines (dense patterns) of a line width and line pitch of 180 nm each and isolated lines (isolated patterns) of a line width of 180 nm. Note that a similar trend may be considered to be exhibited even when using as the light source i-rays or g-rays from a continuous emission light source, an ArF excimer laser or F₂ laser, or EUV light having an oscillation spectrum in the soft X-ray region.

In the figure, the horizontal axis shows the amount of defocus (nm), that is, the offset from the optimal focus (best focus) position, while the vertical axis shows the pattern line width (nm). Further, the curve shown by the letters L/S (line/space) shows the change in line width of dense patterns in the case of double exposure by the method of the present embodiment (about the same as the dense patterns in the case of double exposure by the method of the present embodiment), while the curve shown by the letter D (double) shows the change in line width of isolated patterns in the case of double exposure by the method of the present embodiment. The curve shown by the letter S (single) shows the change in line width of isolated patterns in the case of a single exposure as in the prior art. Note that the first and second focus positions in the case of two exposures are assumed to be equal.

As shown in the figure, the change in line width of dense patterns (L/S) due to defocus tends to be one becoming gradually thicker. In the case of two exposures as well, substantially the same trend is exhibited in change as with single exposure. As opposed to this, the change in line width of isolated patterns (S) due to defocus in the case of single exposure tends to become one of relatively rapid thinning. The range of allowance of focal error (depth of focus) for ensuring the line width error becomes within a predetermined allowable range is small, but in the case of isolated patterns (D) in the case of double exposure by the method of the present embodiment, the change in line width due to defocus tends to be one of relatively gradual thinning. It is possible to reduce the change in line width and possible to increase the depth of focus even from the case of single exposure.

That is, in dense patterns (L/S) and isolated patterns (S), the changes in the line width due to defocus exhibit opposite trends. Therefore, by performing first exposure using the first reticle having reticle patterns comprising isolated patterns plus auxiliary patterns to form dense patterns, then performing second exposure using the second reticle having isolated patterns so as to give the appropriate amount of exposure by these two exposures, taking note of the overlaid isolated patterns, in the first exposure, somewhat thick patterns are formed and, in the second exposure, somewhat thin patterns are formed. The changes in line widths between the first and second exposures due to the amount of defocus cancel each other out and therefore it is possible to obtain an overall line width close to the line width at best focus.

In FIG. 3, for example, if allowing a line width error up to ±20 nm from the line width 180 nm, it is learned that the depth of focus obtained in the first exposure (S) is ±250 nm and the depth of focus obtained by the second exposure (D) by the method of the present embodiment can be increased up to ±340 nm.

Note that FIG. 3 shows the case where the line width of the reticle patterns (isolated patterns) 42a formed on the first reticle R1 used for the first exposure and the line width of the reticle patterns (isolated patterns) 42b formed on the second reticle R2 used for the second exposure are made to match with each other and the amount of first exposure and amount of second exposure are made ½ of the appropriate amount of exposure. The line widths of the patterns 42a and 42b of the first reticle R1 and second reticle R2 may be changed or adjusted to become different from each other, the amount of first exposure and amount of second exposure may be changed or adjusted to become different from each other, the two may be changed or adjusted in inter-relation so that, in FIG. 3, the curve shown by the letter D becomes a straight line in the horizontal direction, and thereby the depth of focus may be made further larger. Further, the line widths, numbers, arrangement, etc. of the isolated patterns 43a are not limited to the above.

In this way, according to the method of the present embodiment, it is possible to reduce the line width error of isolated patterns based on the focus error as systematic error due to unevenness etc., of the surface of the wafer W (photo resist). Further, according to the present invention, it is also possible to reduce the random error as explained below.

That is, according to the present embodiment, since exposure is performed twice by amounts of exposure of ½ of the appropriate amount of exposure as determined by the sensitivity of the photo resist coated on the wafer W, the random error occurring randomly without exhibiting any particular trend is reduced by the averaging effect.

Here, if assuming that the random error for the focus is normally distributed by 3σ=F (μm) where the standard error is σ, the probability of random error due to single exposure ending up out of the range of ±F (μm) is 1% (0.01). As opposed to this, the probability of random error ending up out of the range of ±F (μm) in double exposures as well is 0.01% (0.01×0.01). This shows that it is sufficient to deem the occurrence of random error with a probability of 99% in double exposure occurs for a range of occurrence with a probability of 90% in single exposure, that is, the range of 2σ. That is, by performing exposure twice, when considering the error up to 3σ, it is possible to consider a magnitude of ⅔. Therefore, it is possible to deem that the random error component is reduced to ⅔ by the double exposure. Therefore, the effect due to random error can be reduced, the exposure accuracy improved, and fine patterns formed with a good accuracy.

Note that in the method of the present embodiment, the first and second amounts of exposure in the double exposure are made amounts of ½ of the appropriate amount of exposure. This is most effective from the viewpoint of reducing random error. It is however not necessarily essential for the first and second amounts of exposure to match. The first amount of exposure may be made larger than the second or the second amount of exposure may be made larger than the first. In this case, they may be distributed so that the sum of the first and second amounts of exposure match the appropriate amount of exposure.

Further, the line widths of the reticle patterns 41a and 41b of the first reticle R1 and the second reticle R2 do not necessarily have to be the same and can be made different. In this case, the amount of first exposure and the amount of second exposure can be made different in relation with the line width. Further, the dense patterns comprised of the isolated patterns 42a and auxiliary patterns 43a on the first reticle R1 are not limited in pitch or duty ratio to the above conditions and need not be line-and-space patterns, that is, the interval between the isolated patterns 42a and auxiliary patterns 43a and the interval between the adjoining auxiliary patterns 43a may be made different.

As explained above, by using the method of the present embodiment to form device patterns, random error is reduced and the changes in line width of the isolated patterns due to defocus are suppressed, so the resolution can be made further higher. A microdevice produced using this method has a suitable, uniform line width and is superior in characteristics.

Note that in the present embodiment, the first exposure was performed using the first reticle R1, while the second exposure was performed using the second reticle R2. As opposed to this, however, the same effect can be obtained even if performing the first exposure by the second reticle R2 and the second exposure by the first reticle R1. Note that it is also possible to form the reticle patterns shown in FIG. 2A and FIG. 2B on the same reticle. Further, the illumination conditions, that is, the shape or size of the above secondary light source (intensity distribution of illumination light IL) may also be made different between the first reticle R1 and the second reticle R2.

[Second Embodiment (Formation of Dense Patterns)]

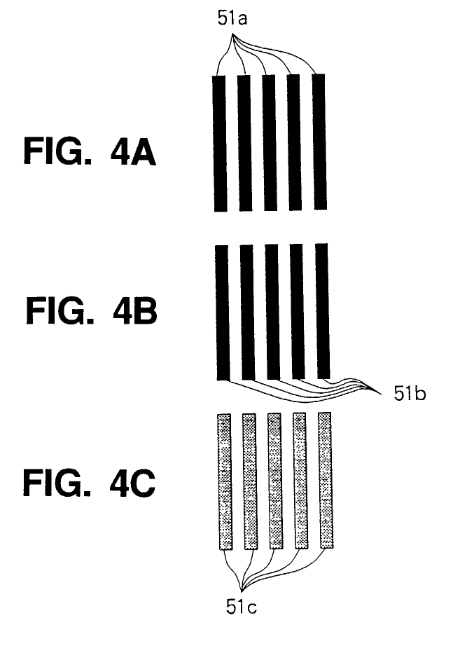

An explanation will be given next of the case of forming dense patterns having periodicity as device patterns with reference to FIG. 4A, FIG. 4B, and FIG. 4C. Note that FIG. 4A and FIG. 4B show reticle patterns formed on the reticle. The shaded portions show light interrupting portions, while the non-shaded portions show the light transmitting portions. FIG. 4C shows the device patterns to be formed or formed on the wafer W. The shaded portions show lines (projections), while the non-shaded portions show the spaces (depressions).

Assume that device patterns comprised of the dense patterns 51c as shown in FIG. 4C as components are formed on a wafer W coated with a photo resist (positive resist) having predetermined sensitivity.

In this case, a first reticle R1 and second reticle R2 formed with the following reticle patterns are prepared. That is, as shown in FIG. 4A, the first reticle R1 is formed with reticle patterns comprised of dense patterns 51a of shapes corresponding to the dense patterns 51c of the device patterns. The second reticle R2, as shown in FIG. 4B, is formed with reticle patterns comprised of dense patterns 51b of shapes corresponding to the dense patterns 51c of the device patterns. The first reticle R1 and the second reticle R2 are fixed and held on the reticle stage 17. Note that the conditions for formation of the patterns are completely the same for the first reticle R1 and second reticle R2.

First, the stage control system 13 controls the reticle position adjustment mechanism etc. of the reticle stage 17 to set the first reticle R1 at a predetermined illumination position (initial position of scan start). After this, in the same way as the first embodiment, it suitably selects and adjusts one or both of the oscillation frequency of the laser light by the excimer laser light source 2 and the movement speed of the wafer stage 22 in relation with the field etc. due to the illumination field stop system 11 to perform first exposure so as to give a substantial amount of exposure at the wafer W of ½ of the appropriate amount of exposure as determined by the sensitivity of the photo resist coated on the wafer W.

Next, the stage control system 13 controls the reticle position adjustment mechanism etc. of the reticle stage 17 to set the second reticle R2 at a predetermined illumination position and, in the same way as above, performs second exposure so as to give a substantial amount of exposure at the wafer W of ½ of the appropriate amount of exposure as determined by the sensitivity of the photo resist coated on the wafer W. This forms the device patterns 51c given the appropriate amount of exposure by the double exposure on the wafer W.

According to the method of the present embodiment, since the first and second reticles formed with the same patterns are used for double exposure by amounts of ½ of the appropriate amount of exposure as determined by the sensitivity of the photo resist coated on the wafer W so as to form device patterns with an appropriate amount of exposure, random error occurring randomly without exhibiting any particular trend is reduced by the averaging effect. Details of the reduction of the random error were explained in the first embodiment, so will be omitted here.

Note that in the method of the present embodiment, the first and second amounts of exposure in the two exposures are made amounts of ½ of the appropriate amount of exposure. Such an exposure method is extremely effective from the viewpoint of reducing random error. It is however not necessarily essential for the first and second amounts of exposure to match. The first amount of exposure may be made larger than the second or the second amount of exposure may be made larger than the first. In this case, they may be distributed so that the sum of the first and second amounts of exposure match the appropriate amount of exposure.

Further, the line widths of the reticle patterns 51a and 51b of the first reticle R1 and second reticle R2 do not necessarily have to be the same. They may be made different from each other. In this case, the amount of first exposure and the amount of second exposure may be made different in relation with the line widths.

Further, in the present embodiment, two reticles, that is, the first reticle R1 and the second reticle R2, are used. This is effective when making the exposure conditions different from each other, but it is also possible to use either reticle for the first exposure and second exposure. Note that reticle patterns shown in FIG. 4A and FIG. 4B may also be formed on the same reticle.

[Third Embodiment (Formation of Isolated Patterns)]

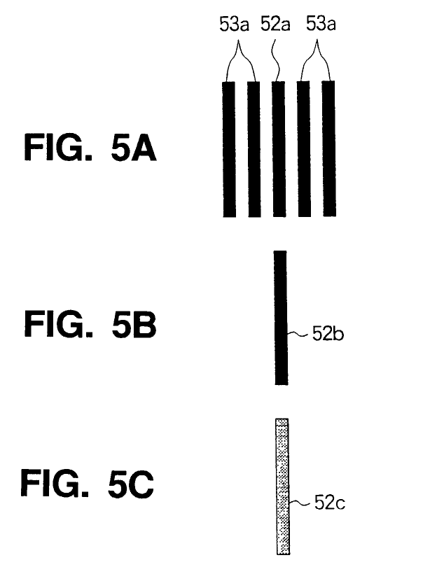

An explanation will be given next of the case of forming isolated patterns as device patterns with reference to FIG. 5A, FIG. 5B, and FIG. 5C. Note that FIG. 5A and FIG. 5B show reticle patterns formed on the reticle. The shaded portions show light interrupting portions, while the non-shaded portions show the light transmitting portions. FIG. 5C shows the device patterns to be formed or formed on the wafer W. The shaded portions show lines (projections), while the non-shaded portions show the spaces (depressions).

Assume that device patterns comprised of the isolated patterns 52c as shown in FIG. 5C as components are formed on a wafer W coated with a photo resist (positive resist) having a predetermined sensitivity.

In this case, a first reticle R1 and second reticle R2 formed with the following reticle patterns are prepared. That is, as shown in FIG. 5A, the first reticle R1 is formed with reticle patterns comprised of dense patterns formed by patterns 52a of shapes corresponding to the isolated patterns 52c of the device patterns plus a plurality of auxiliary patterns 53a in their vicinity. The second reticle R2, as shown in FIG. 5B, is formed with reticle patterns comprised of patterns 52b of shapes corresponding to the isolated patterns 52c of the device patterns. The first reticle R1 and the second reticle R2 are fixed and held on the reticle stage 17. Note that the isolated patterns 52a and 52b are exactly the same in formation conditions. Further, the conditions for formation of the dense patterns comprised of the isolated patterns 52a and auxiliary patterns 53a are assumed to be the same as the dense patterns (42a, 43a) explained with reference to the first embodiment (FIG. 2A).

First, the stage control system 13 controls the reticle position adjustment mechanism etc. of the reticle stage 17 to set the first reticle R1 at a predetermined illumination position (initial position of scan start) and suitably selects and adjusts one or both of the oscillation frequency of the laser light by the excimer laser light source 2 and the movement speed of the wafer stage 22 in relation with the field etc. due to the illumination field stop system 11 and performs first exposure so as to give a substantial amount of exposure at the wafer W of ½ of the appropriate amount of exposure as determined by the sensitivity of the photo resist coated on the wafer W.

Next, the stage control system 13 controls the reticle position adjustment mechanism etc. of the reticle stage 17 to set the second reticle R2 at a predetermined illumination position and performs second exposure so as to give a substantial amount of exposure at the wafer W of ½ of the appropriate amount of exposure as determined by the sensitivity of the photo resist coated on the wafer W in the same way as above. This forms the device patterns 52c given the appropriate amount of exposure by double exposure on the wafer W. Note that the images transferred by the auxiliary patterns 53a are exposed by ½ of the appropriate amount of exposure, so do not remain after development.

In dense patterns and isolated patterns, the changes in the line width due to defocus exhibit opposite trends in the same way as explained in the first embodiment, so by performing exposure using the first reticle R1 having reticle patterns comprising dense patterns formed by isolated patterns 52a plus auxiliary patterns 53a, then performing exposure using the second reticle R2 having the isolated patterns 52b so as to give the appropriate amount of exposure by the double exposure, taking note of the overlaid isolated patterns, in the first exposure, somewhat thick patterns are formed and, in the second exposure, somewhat thin patterns are formed. The changes in line widths between the first and second exposures due to the amount of defocus cancel each other out and therefore it is possible to obtain an overall line width close to the line width at best focus and possible to increase the depth of focus.

Note that the line widths of the reticle patterns 52a formed on the first reticle R1 used for the first exposure and the line widths of the reticle patterns 52b formed on the second reticle R2 used for the second exposure do not necessarily have to match and may be made different. Further, in relation with the line width or independently, it is possible to made the first amount of exposure and the second amount of exposure different in a range less than the appropriate amount of exposure as determined by the sensitivity of the photo resist. By doing this, it is possible to further increase the depth of focus. Further, the line widths, numbers, arrangement, etc. of the auxiliary patterns 65a are not limited to the above.

In this way, according to the method of the present embodiment, it is possible to reduce the error in line width of the isolated patterns due to focus error as systematic error due to the unevenness etc. of the wafer W (resist) surface. Further, if performing double exposure according to the method of the present embodiment, in the same way as explained in the above first embodiment, the random error occurring randomly without exhibiting any particular trend is reduced by the averaging effect, the exposure accuracy is improved, and fine patterns can be formed with a good accuracy.

Note that in the present embodiment, the first exposure was performed using the first reticle R1, while the second exposure was performed using the second reticle R2. As opposed to this, however, the same effect can be obtained even if performing the first exposure by the second reticle R2 and the second exposure by the first reticle R1. Note that it is also possible to form the reticle patterns shown in FIG. 5A and FIG. 5B on the same reticle. Further, the illumination conditions may be made different between the first reticle R1 and second reticle R2. For example, it is possible to use an annular shaped aperture stop for annular illumination of the first reticle R1 and use a circular shaped aperture stop for ordinary illumination of the second reticle R2. Further, in the second exposure using the second reticle R2 (isolated patterns 52b of FIG. 5B), it is possible to adopt the so-called cumulative focus method of irradiating the illumination light IL at a plurality of positions relative to the direction of the optical axis of the projection optical system PL for each point in the exposure region on the wafer W. Note that the cumulative focus method suitable for a scan exposure apparatus is for example disclosed in Japanese Unexamined Patent Publication (Kokai) No. 4-277612 and its corresponding U.S. Pat. No. 5,194,893 and Japanese Unexamined Patent Publication (Kokai) No. 6-314646 and its corresponding U.S. Pat. No. 5,742,376. The disclosures of that Japanese publications and U.S. patents are adopted as part of the description of this specification in so far as the domestic laws of the country designated or country elected by this international application allow.

[Fourth Embodiment (Formation of Isolated Patterns)]

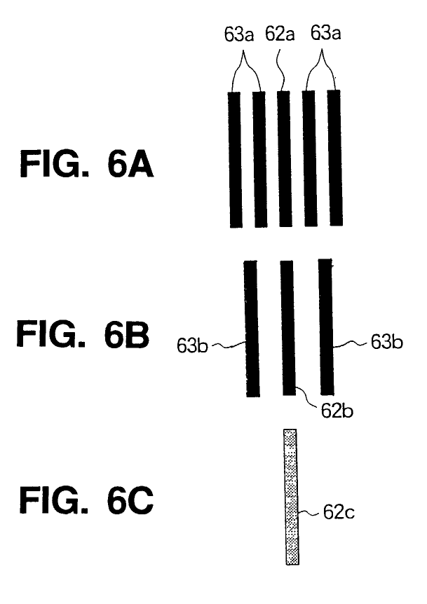

An explanation will be given next of the case of forming isolated patterns as device patterns with reference to FIG. 6A, FIG. 6B, and FIG. 6C. Note that FIG. 6A and FIG. 6B show reticle patterns formed on the reticle. The shaded portions show light interrupting portions, while the non-shaded portions show the light transmitting portions. FIG. 6C shows the device patterns to be formed or formed on the wafer W. The shaded portions show lines (projections), while the non-shaded portions show spaces (depressions).

Assume that device patterns comprising the isolated patterns 62c as shown in FIG. 6C as components are formed on a wafer W coated with a photo resist (positive resist) having predetermined sensitivity.

In this case, a first reticle R1 and second reticle R2 formed with the following reticle patterns are prepared. That is, as shown in FIG. 6A, the first reticle R1 is formed with reticle patterns comprised of dense patterns formed by patterns 62a of shapes corresponding to the isolated patterns 62c of the device patterns and a plurality of auxiliary patterns 63a in their vicinity. Specifically, the line width of the isolated patterns 62a is 0.18 μm. 0.18 μm line width auxiliary patterns 63a are formed at a space of 0.18 μm (light transmitting portion) from these.

The second reticle R2, as shown in FIG. 6B, is formed with reticle patterns comprised of relatively spare periodic patterns, formed by patterns 62b of shapes corresponding to the isolated patterns 62c of the device patterns plus auxiliary patterns 63b at the two sides, not as dense as the dense patterns of the first reticle R1. Specifically, the line width of the patterns 62b is 0.18 μm, the same as the line width of the isolated patterns 62a of the first reticle R1. 0.12 μm line width auxiliary patterns 63b are formed at a space of 0.39 μm (light transmitting portions) from these. The first reticle R1 and the second reticle R2 are fixed and held on the reticle stage 17.

First, the stage control system 13 controls the reticle position adjustment mechanism etc. of the reticle stage 17 to set the first reticle R1 at a predetermined illumination position (initial position of scan start) and suitably selects and adjusts one or both of the oscillation frequency of the laser light by the excimer laser light source 2 and the movement speed of the wafer stage 22 in relation with the field etc. due to the illumination field stop system 11 to perform first exposure so as to give a substantial amount of exposure at the wafer W of ½ of the appropriate amount of exposure as determined by the sensitivity of the photo resist coated on the wafer W.

Next, the stage control system 13 controls the reticle position adjustment mechanism etc. of the reticle stage 17 to set the second reticle R2 at a predetermined illumination position and performs a second exposure so as to give a substantial amount of exposure at the wafer W of ½ of the appropriate amount of exposure as determined by the sensitivity of the photo resist coated on the wafer W in the same way as above. This forms the device patterns 62c given the appropriate amount of exposure by the double exposure on the wafer W. Note that the images transferred by the auxiliary patterns 63a and 63b are exposed by ½ of the appropriate amount of exposure, so do not remain after development.

In dense patterns, the change in the line width due to defocus tends to become one becoming thicker. In periodic patterns which are sparser than this, the change in the line width due to defocus tends to be one becoming thinner than the dense patterns. Therefore, by performing first exposure using the first reticle having reticle patterns comprised of dense periodic patterns formed by isolated patterns 62a plus auxiliary patterns 63a, then performing second exposure using the second reticle having reticle patterns comprised of periodic patterns (sparser than the dense patterns of the first reticle R1) formed the isolated patterns 62b plus auxiliary patterns 63b so as to give the appropriate amount of exposure by these double exposure, taking note of the overlaid isolated patterns, in the first exposure, somewhat thick patterns are formed and, in the second exposure, patterns thinner than the first are formed. The changes in line widths due to the first and second exposures due to the amount of defocus are averaged and therefore it is possible to obtain an overall line width close to the line width at best focus and possible to increase the depth of focus.

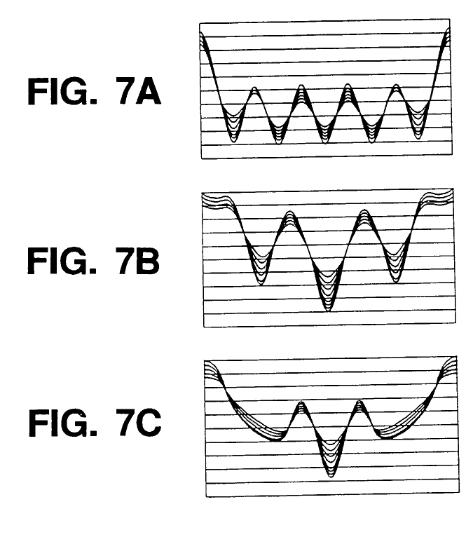

FIG. 7A, FIG. 7B, and FIG. 7C are views of the distribution of image intensity on the wafer W at a plurality of focus positions. FIG. 7A shows the distribution of image intensity when exposing and transferring the periodic dense patterns shown in FIG. 6A, FIG. 7B shows the distribution of image intensity when exposing and transferring the periodic patterns shown in FIG. 6B, and FIG. 7C shows the distribution of image intensity combining the two.

If performing exposure using the first reticle R1, as shown in FIG. 7A, pattern images are formed on the wafer W with a low intensity at the portions corresponding to the light interrupting portions 62a and 63a of the reticle patterns and a high intensity at the portions corresponding to the light transmitting portions. Further, if performing exposure using the second reticle R2, patterns are formed with a low intensity at the portions corresponding to the light interrupting portions 62b and 63b of the reticle pattern and a high intensity at the portions corresponding to the light transmitting portions.

If performing double exposure using the first reticle R1 and second reticle R2, as shown in FIG. 7C, pattern images are formed on the wafer W with a low intensity at portions of the wafer W corresponding to the reticle patterns 62a and 62b and a high intensity at other portions. Development in relation with the intensity portions enables formation of the isolated patterns 62c shown in FIG. 6C.

Note that the line width of the reticle patterns 62a formed on the first reticle R1 used for the first exposure and the line width of the reticle patterns 62b formed on the second reticle R2 used for the second exposure do not necessarily have to match and may be made different. Further, in relation with the line width or independently, it is possible to make the first amount of exposure and the second amount of exposure different in a range less than the appropriate amount of exposure as determined by the sensitivity of the photo resist. By doing this, it is possible to further increase the depth of focus. Further, the line widths, numbers, arrangement, etc. of the auxiliary patterns 63a and 63b are not limited to the above.

In this way, according to the method of the present embodiment, it is possible to reduce the error in line width of the isolated patterns due to focus error as systematic error due to the unevenness etc. of the wafer W (resist) surface. Further, if performing double exposure according to the method of the present embodiment, in the same way as explained in the above first embodiment, the random error occurring randomly without exhibiting any particular trend is reduced by Note that in the present embodiment, the first exposure was performed using the first reticle R1, while the second exposure was performed using the second reticle R2. As opposed to this, however, the same effect can be obtained even if performing the first exposure by the second reticle R2 and the second exposure by the first reticle R1. Note that it is also possible to form the reticle patterns shown in FIG. 6A and FIG. 6B on the same reticle. Further, the illumination conditions may be made different between the first reticle R1 and second reticle R2. For example, it is possible to apply the annular illumination method to both the first and second reticles R1 and R2 and make at least one of the annular ratio (ratio of outer diameter and inner diameter) and annular width different in accordance with the conditions of formation of the pattern (line width, pitch, etc.) between the first reticle R1 and second reticle R2. This can be realized by providing the switch revolver 5 with a plurality of annular aperture stops with a different at least one annular ratio and annular width.

Further, in the present embodiment, a positive resist was used as the photo resist, but it is possible to use a negative resist and form isolated space patterns (depressions) such as contact holes at positions corresponding to the isolated patterns 62c.

[Fifth Embodiment (Formation of Isolated Patterns)]

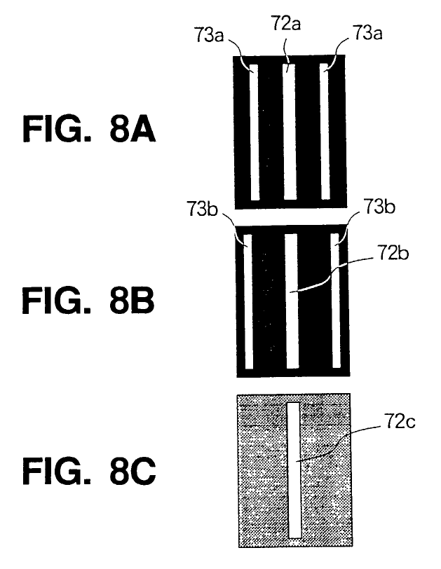

An explanation will be given next of the case of forming isolated patterns as device patterns with reference to FIG. 8A, FIG. 8B, and FIG. 8C. Note that FIG. 8A and FIG. 8B show reticle patterns formed on the reticle. The shaded portions show light interrupting portions, while the non-shaded portions show the light transmitting portions. FIG. 8C shows the device patterns to be formed or formed on the wafer W. The shaded portions show the spaces (depressions), while the non-shaded portions show the lines (projections).

Assume that device patterns comprised of the isolated patterns 72c as shown in FIG. 8C as components are formed on a wafer W coated with a photo resist (negative resist) having a predetermined sensitivity.

In this case, a first reticle R1 and second reticle R2 formed with the following reticle patterns are prepared. That is, the first reticle R1 is formed with reticle patterns comprised of relatively dense periodic patterns formed by patterns (light transmitting portions) 72a of shapes corresponding to the isolated patterns 72c of the device patterns plus auxiliary patterns (light transmitting portions) 73a at their two sides. Specifically, the line width of the isolated patterns 72a is 0.18 μm. 0.09 μm auxiliary patterns 73a are formed at a space of 0.225 μm (light interrupting portion) from these.

The second reticle R2, as shown in FIG. 8B, is formed with reticle patterns comprised of periodic patterns, sparser than the periodic pattern of the first reticle R1, formed by patterns (light transmitting portions) 72b of shapes corresponding to the isolated patterns 72c of the device patterns plus auxiliary patterns (light transmitting portions) 73b at the two sides. Specifically, the line width of the isolated patterns 72b is 0.18 μm, the same as the line width of the isolated patterns 72a of the first reticle R1. 0.09 μm auxiliary patterns 73b are formed at a space of 0.315 μm (light interrupting portions) from these.

First, the stage control system 13 controls the reticle position adjustment mechanism etc. of the reticle stage 17 to set the first reticle R1 at a predetermined illumination position (initial position of scan start) and suitably selects and adjusts one or both of the oscillation frequency of the laser light by the excimer laser light source 2 and the movement speed of the wafer stage 22 in relation with the field etc. due to the illumination field stop system 11 to perform first exposure so as to give a substantial amount of exposure at the wafer W of ½ of the appropriate amount of exposure as determined by the sensitivity of the photo resist coated on the wafer W.

Next, the stage control system 13 controls the reticle position adjustment mechanism etc. of the reticle stage 17 to set the second reticle R2 at a predetermined illumination position and perform second exposure so as to give a substantial amount of exposure at the wafer W of ½ of the appropriate amount of exposure as determined by the sensitivity of the photo resist coated on the wafer W in the same way as above. This forms the device patterns 72c given the appropriate amount of exposure by the double exposure on the wafer W. Note that the images transferred by the auxiliary patterns 73a and 73b are exposed by ½ of the appropriate amount of exposure, so do not remain after development.

In relatively dense periodic patterns, the change in line width due to defocus tends to become one becoming thicker. In relatively sparse periodic patterns, the change in line width due to defocus tends to be one becoming thinner than the dense periodic patterns. Therefore, by performing first exposure using a first reticle having reticle patterns comprised of relatively dense periodic patterns formed by isolated patterns plus auxiliary patterns, then performing second exposure using a second reticle having reticle patterns comprised of relatively sparse periodic patterns formed by isolated patterns plus auxiliary patterns so as to give the appropriate amount of exposure by the double exposure, taking note of the overlaid isolated patterns, in the first exposure, somewhat thick patterns are formed and, in the second exposure, patterns thinner than the first are formed. The changes in line widths due to the first and second exposures due to the amount of defocus are averaged and therefore it is possible to obtain an overall line width close to the line width at best focus and possible to increase the depth of focus.

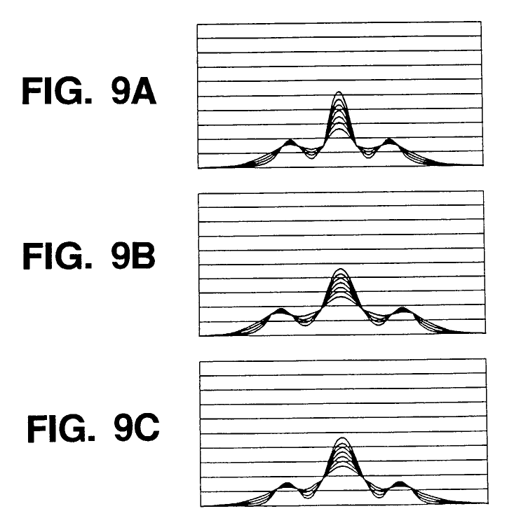

FIG. 9A, FIG. 9B, and FIG. 9C are views of the distribution of image intensity on the wafer W at a plurality of focus positions. FIG. 9A shows the distribution of image intensity when exposing and transferring the dense patterns shown in FIG. 8A, FIG. 9B shows the distribution of image intensity when exposing and transferring the periodic patterns shown in FIG. 8B, and FIG. 9C shows the distribution of image intensity combining the two.

If performing exposure using the first reticle R1, as shown in FIG. 9A, pattern images are formed on the wafer W with a high intensity at portions corresponding to the light transmitting portions 72a and 73a of the reticle patterns in accordance with the light width and with a low intensity at portions corresponding to the light interrupting portions. Further, if performing exposure using the second reticle R2, pattern images are formed with a high intensity at portions corresponding to the light transmitting portions 72b and 73b of the reticle pattern in accordance with the light width and with a low intensity at portions corresponding to the light interrupting portions.

If performing double exposure using the first reticle R1 and second reticle R2, as shown in FIG. 9C, pattern images are formed on the wafer W with a highest intensity at the portions corresponding to the reticle patterns 72a and 72b and at a low intensity at other portions. Development in relation with the intensity portions enables formation of the isolated patterns 72c shown in FIG. 8C.

Note that the line width of the reticle patterns 72a formed on the first reticle R1 used for the first exposure and the line width of the reticle patterns 72b formed on the second reticle R2 used for the second exposure do not necessarily have to match and may be made different. Further, in relation with the line width or independently, it is possible to make the first amount of exposure and the second amount of exposure different in a range less than the appropriate amount of exposure as determined by the sensitivity of the photo resist. By doing this, it is possible to further increase the depth of focus. Further, the line widths, numbers, arrangement, etc. of the auxiliary patterns 73a and 73b are not limited to the above.

In this way, according to the method of the present embodiment, it is possible to reduce the error in line width of the isolated patterns due to focus error as systematic error due to the unevenness etc. of the wafer W (resist) surface. Further, if performing double exposure according to the method of the present embodiment, in the same way as explained in the above first embodiment, the random error occurring randomly without exhibiting any particular trend is reduced by the averaging effect. Further, the illumination conditions may be made different between the first reticle R1 and the second reticle R2.

Note that in the present embodiment, the first exposure was performed using the first reticle R1, while the second exposure was performed using the second reticle R2. As opposed to this, however, the same effect can be obtained even if performing the first exposure by the second reticle R2 and the second exposure by the first reticle R1. Note that it is also possible to form the reticle patterns shown in FIG. 8A and FIG. 8B on the same reticle.

Further, in the present embodiment, a negative resist was used as the photo resist, but it is possible to use a positive resist and form isolated space patterns (depressions) such as contact holes at positions corresponding to the isolated patterns 72c.

[Sixth Embodiment (Formation of Periodic Patterns)]

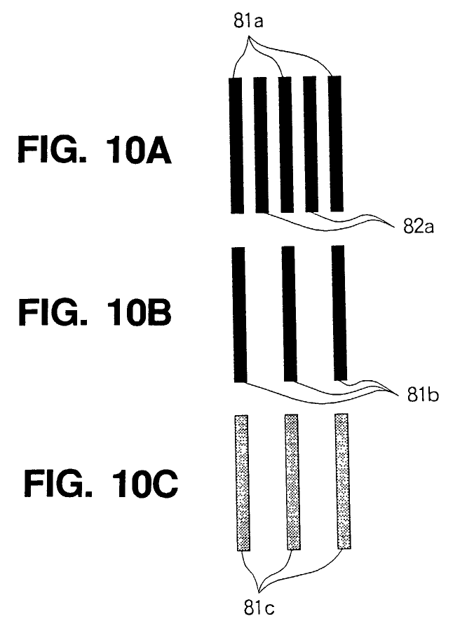

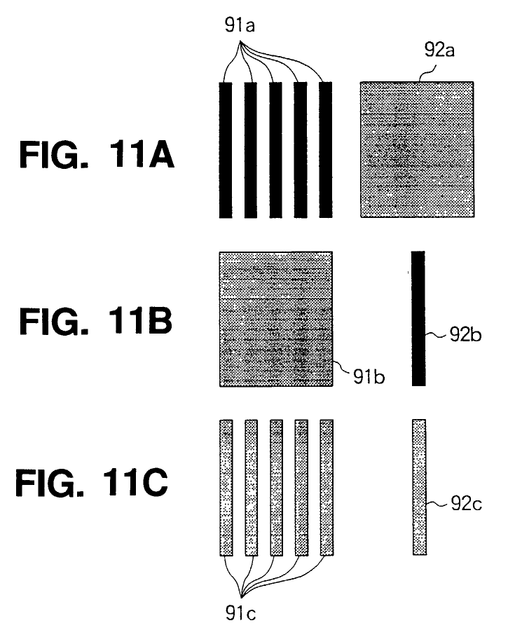

An explanation will be given here, referring to FIG. 10A, FIG. 10B, and FIG. 10C, of the case where forming as the device patterns periodic patterns 81c of one line and three spaces so that the interval (space) between adjoining patterns (lines) becomes three times the pattern line width. Note that FIG. 10A and FIG. 10B show reticle patterns formed on a reticle. The shaded portions show the light interrupting portions while the non-shaded portions show the light transmitting portions. FIG. 10C shows the device patterns to be formed or formed on a wafer W. The shaded portions show lines (projections), while the non-shaded portions show spaces (depressions).

Assume that device patterns comprised of the periodic patterns 81c as shown in FIG. 10C as components are formed on a wafer W coated with a photo resist (positive resist) having a predetermined sensitivity.

In this case, a first reticle R1 and second reticle R2 formed with the following reticle patterns are prepared. That is, the first reticle R1 is formed with reticle patterns comprised as shown in FIG. 10A of dense patterns formed by periodic patterns 81a of shapes corresponding to the periodic patterns 81c of the device patterns and auxiliary patterns 82a added to portions between these. Note that the auxiliary patterns 82a are the same in line width as the periodic patterns 81a, while the periodic patterns 81a and auxiliary patterns 82a have pitches double the line width and constitute line-and-space patterns giving a duty ratio of 1:1.

The second reticle R2, as shown in FIG. 10B, is formed with second reticle patterns comprised of a periodic patterns 81b of shapes corresponding to the periodic patterns 81c of the device patterns. The first reticle R1 and the second reticle R2 are fixed and held arranged on the reticle stage 17. Note that the periodic patterns 81b are exactly the same in conditions of formation (line width, pitch, etc.) as the periodic patterns 81a.

First, the stage control system 13 controls the reticle position adjustment mechanism etc. of the reticle stage 17 to set the first reticle R1 at a predetermined illumination position (initial position of scan start) and suitably selects and adjusts one or both of the oscillation frequency of the laser light by the excimer laser light source 2 and the movement speed of the wafer stage 22 in relation with the field etc. due to the illumination field stop system 11 to perform first exposure so as to give a substantial amount of exposure at the wafer W of ½ of the appropriate amount of exposure as determined by the sensitivity of the photo resist coated on the wafer W.

Next, the stage control system 13 controls the reticle position adjustment mechanism etc. of the reticle stage 17 to set the second reticle R2 at a predetermined illumination position and performs second exposure so as to give a substantial amount of exposure at the wafer W of ½ of the appropriate amount of exposure as determined by the sensitivity of the photo resist coated on the wafer W in the same way as above. This forms the device patterns 81c given the appropriate amount of exposure by this double exposure on the wafer W. Note that the images transferred by the auxiliary patterns 82a are exposed by ½ of the appropriate amount of exposure, so do not remain after development.

In dense patterns, the change in the line width due to defocus tends to become one becoming thicker. In sparser periodic patterns, the change in the line width due to defocus tends to become one becoming thinner than the dense patterns. Therefore, by performing first exposure using a first reticle having reticle patterns comprising dense patterns formed by periodic patterns plus auxiliary patterns, then performing second exposure using a second reticle having periodic patterns and giving the appropriate amount of exposure by the double exposure, taking note of the overlaid periodic patterns, in the first exposure, somewhat thick patterns are formed and, in the second exposure, patterns thinner than the first are formed. The changes in line widths due to the first and second exposures due to the amount of defocus are averaged and therefore it is possible to obtain an overall line width close to the line width at best focus and possible to increase the depth of focus.

In this way, according to the method of the present embodiment, it is possible to reduce the line width error of the periodic patterns based on the focus error as systematic error due to unevenness of the wafer W (resist) surface. Further, according to the method of the present embodiment, since double exposure is performed, the random error occurring randomly without exhibiting any particular trend is reduced by the averaging effect in the same way as explained with reference to the above first embodiment.

Note that the line widths of the reticle patterns 81a and 81b of the first reticle R1 and second reticle R2 do not necessarily have to be the same. They may be made different from each other. In this case, the amount of first exposure and the amount of second exposure may be made different in relation with the line widths. The line widths, numbers, arrangement, etc. of the auxiliary patterns 82a are not limited to the above.

Further, in this embodiment, the first exposure was performed using the first reticle R, while the second exposure was performed using the second reticle R2. As opposed to this, however, the same effect can be obtained even if performing the first exposure by the second reticle R2 and the second exposure by the first reticle R1. Note that it is also possible to form the reticle patterns shown in FIG. 10A and FIG. 10B into the same reticle. Further, it is also possible to make the illumination conditions for the first reticle R1 and second reticle R2 different. For example, it is possible use the annular illumination method for the first reticle R1 and the ordinary illumination method for the second reticle R2 or use the annular illumination methods for both the first and second reticles R1 and R2 and make at least one of the annular ratio and annular width different in accordance with the pattern formation conditions (pitch etc.)

Note that the embodiments explained above were described to facilitate the understanding of the present invention and were not described to limit the present invention. Therefore, the elements disclosed in the above embodiments include all design modifications and equivalents falling under the technical range of the present invention.

For example, in the above embodiments, the desired device patterns were formed by first and second exposures, but the present invention is not limited to this. It is also possible to form device patterns by more (three or more) exposures. Further, the size and shape of the patterns, the wavelength of the light source, the numerical aperture (NA) of the projection optical system, the shape of the aperture (field stop) of the illumination optical system, etc. are also not limited to the above and can be modified in any manner.

Further, the conditions, for example, the intensity distribution of the exposure illumination light defined by the aperture stop of the revolver 5 (shape or size of secondary light source), that is, only the illumination conditions, were made different between the first scan exposure and the second scan exposure, but it is also possible to make other conditions different, together with the illumination conditions or alone, such as the numerical aperture NA defined by the variable aperture stop arranged at the pupil plane of the projection optical system PL, the use of the cumulative focal method moving the imaging plane of the projection optical system PL and wafer W during the exposure in a direction along the optical axis disclosed in Japanese Unexamined Patent Publication (Kokai) No. 4-277612 (U.S. Pat. No. 5,194,893) or Japanese Unexamined Patent Publication (Kokai) No. 6-314646 (U.S. Pat. No. 5,742,376), and the use of an optical filter (so-called pupil filter) changing part of the optical characteristics (amplitude transmittance, phase, etc.) of the imaging flux generated from the reticle pattern and distributed at the pupil plane of the projection optical system (Fourier transform plane). Further, it is possible to use at least one of the reticle patterns formed at the first and second reticles as spatial frequency conversion type (Shibuya-Levenson type), edge enhancing type, halftone type, or other phase shift pattern or combine with the phase shift pattern at least one of the modified illumination method for changing the shape or size of the secondary light source, cumulative focus method, and pupil filter.

In the above first to sixth embodiments, it is also possible to adopt the sequence of transferring the first and second reticle patterns on to one shot area on the wafer, then making the wafer step and transferring the first and second reticle patterns on the next shot area or to adopt the sequence of using the step-and-scan system (or step-and-repeat system) to successively transfer first reticle patterns, then similarly successively transfer the second reticle pattern to all of the shot areas on the wafer. In particular, the latter is advantageous in the point of keeping the reduction of the throughput to a minimum when changing the conditions between the first exposure and second exposure.

If adopting the present invention as explained above, the random error at the time of exposure is reduced and fine patterns can be formed with a good accuracy. Further, the change in line width of the device patterns due to defocus may be reduced and a line width realized close to the line width when exposing by the best focus over the entire pattern. Further, the processing speed of the exposure can be improved and the cost can be reduced. In addition, when forming device patterns having dense patterns and isolated patterns, the common depth of focus can be enlarged and the resolution can be raised.

Note that instead of a fly-eye lens arranged in the illumination optical system, a rod integrator may also be used or a combination of a fly-eye lens and rod integrator may be used. In this case, the rod integrator has an incidence plane substantially matching with the Fourier transform plane in the illumination optical system and an emission plane substantially conjugate with the pattern surface of the reticle R in the illumination optical system. Therefore, the illumination field stop system 11 (fixed blind and movable blind) are arranged in proximity to the emission plane of the rod integrator, while the aperture stop on the revolver 5 is arranged in proximity to the incidence plane of the rod integrator or is arranged at the Fourier transform plane (pupil surface) set between the rod integrator and reticle R.

Further, the revolver 5 was used for the modified illumination or change of the σ-value etc, but for example it is also possible to make at least one optical element arranged between the excimer laser light source 2 and the optical integrator movable and change the intensity distribution of the illumination light on the incidence plane of the optical integrator. Further, by further arranging a pair of conical prisms (axicons) at the light source 2 side from at least one optical element and adjusting the interval relating to the direction of the optical axis of the pair of axicons, the illumination light on the incident surface of the optical integrator may be changed to an annular shape with an illumination density higher at the outside than at the center. This enables the intensity distribution of the illumination light to be changed on the emission side focal plane in the case of a fly-eye lens and on the Fourier transform plane of the illumination optical system set between the emission plane and reticle R in the case of a rod integrator. Further, even if the σ-value is made smaller or the ordinary illumination is changed to modified illumination (for example, annular illumination), the loss of light of the illumination light along with the change can be greatly reduced and the high throughput can be maintained.

Further, the projection optical system PL may be a refraction system comprised of only a plurality of refraction optical elements or a reflection system comprised of only a plurality of reflection optical elements and further may be an equal-magnification or enlargement type. Note that the reflection and refraction type projection optical system may be any of an optical system having at least a beam splitter and a concave mirror as reflection optical elements, an optical system having a concave mirror and mirror without using a beam splitter as the reflection optical elements shown in FIG. 1, and an optical system arranging a plurality of refraction optical elements and two reflection optical elements (at least one of which being a concave mirror) such as disclosed in U.S. Pat. No. 5,788,229.

Further, the present invention may also be applied to a projection exposure apparatus for transferring circuit patterns to a glass substrate, silicon wafer, etc. to produce a reticle or mask in addition to a projection exposure apparatus used for the production of a semiconductor element, liquid crystal display, thin film magnetic head, and imaging element (CCD etc.). Here, an exposure apparatus using DUV (distant ultraviolet) light, VUV (vacuum ultraviolet) light etc. generally use a transmission type reticle and uses silica glass, fluorine-doped silica glass, fluorite, magnesium fluoride, crystallized quartz, etc. as the reticle substrate. Further, an EUV exposure apparatus uses a reflection type mask, while a proximity type X-ray exposure apparatus or mask projection system electron ray exposure apparatus etc. use a transmission type mask (stencil mask, membrane mask) and use a silicon wafer as the mask substrate.

Note that as the light source, instead of using an excimer laser etc., it is also possible to use for example an infrared region or visible region single wavelength laser light emitted from a DFB semiconductor laser or fiber laser amplified by for example an erbium (or both erbium and yttrium) doped fiber amplifier and use the harmonic obtained by converting the wavelength to ultraviolet light using a nonlinear optical crystal.

For example, if the oscillation wavelength of the single wavelength laser is made a range of 1.51 to 1.59 Am, an 8th harmonic of an oscillation wavelength in the range of 189 to 199 nm or a 10th harmonic of an oscillation wavelength in the range of 151 to 159 nm is output. In particular, if the oscillation wavelength is made one in the range of 1.544 to 1.553 μm, ultraviolet light of an 8th harmonic in the range of 193 to 194 nm, that is, a wavelength substantially the same as that of an ArF excimer laser, is obtained. If the oscillation wavelength is made one in the range of 1.57 to 1.58 μm, ultraviolet light of a 10th harmonic in the range of 157 to 158 nm, that is, a wavelength substantially the same as that of an F₂ laser, is obtained.

Further, if the oscillation wavelength is made one in the range of 1.03 to 1.12 μm, a 7th harmonic of an oscillation wavelength in the range of 147 to 160 nm is output. In particular, if the oscillation wavelength is made one in the range of 1.099 to 1.106 μm, ultraviolet light of a 7th harmonic in the range of 157 to 158 nm, that is, a wavelength substantially the same as that of an F₂ laser, is obtained. Note that as the single wavelength oscillation laser, a yttrium-doped fiber laser is used.

The semiconductor device is produced through a step of design of the functions and performance of the circuit, a step of fabrication of a reticle based on the design step, a step of transferring a pattern of a reticle on a wafer using an exposure apparatus explained in the above embodiments, a step of assembly (including dicing, packaging, etc.), and an inspection step.

Further, the exposure apparatus of the present embodiment may be produced by assembling an illumination optical system and a projection optical system comprised of a plurality of optical elements in the exposure apparatus body and performing optical adjustment, attaching the reticle stage or wafer stage comprised of a large number of mechanical parts to the exposure apparatus body and connecting wiring and piping, and further performing overall adjustment (electrical adjustment, confirmation of operation, etc.). Note that the exposure apparatus is desirably manufactured in a clean room controlled in temperature and cleanness etc.

All of the content of the disclosure of Japanese Patent Application No. 9-3688230 filed on Dec. 26, 1997, including the specification, claims, drawings, and abstract, are incorporated here by reference in its entirety.

What is claimed:

1. An exposure method for forming a device pattern on a photosensitive substrate, comprising a step of overlaying and transferring on the photosensitive substrate a first pattern including a pattern of shape corresponding to the device pattern and a second pattern having substantive periodicity in a predetermined direction.

2. An exposure apparatus which forms a device pattern on a photosensitive substrate, comprising:
a holder which selectively arranges, on a light path of exposure, a first pattern including a pattern of shape corresponding to the device pattern and a second pattern including a pattern having substantive periodicity in a predetermined direction so that the first and second patterns are transferred on the photosensitive substrate and
a position adjuster which adjusts the relative positions of projected images of the first and second patterns with the photosensitive substrate so that the first pattern and the second pattern can be overlaid and transferred on the photosensitive substrate.

3. An exposure apparatus as set forth in claim 1, wherein the second pattern includes a pattern not present in the device pattern.

4. An exposure apparatus as set forth in claim 1, wherein at least one of the first pattern and the second pattern is a phase shift pattern.

5. An exposure method as set forth in claim 1, wherein:
the first pattern and the second pattern are transferred by an illumination beam through a projection system on the photosensitive substrate and
the first pattern and the second pattern are transferred on the photosensitive substrate under different illumination conditions.

6. An exposure method as set forth in claim 1, wherein an amount of exposure at the time of transfer of the first pattern and an amount of exposure at the time of transfer of the second pattern are different.

7. An exposure method as set forth in claim 1, wherein the changes in line widths of pattern images in accordance with positions in the direction of an optical axis of the projection system when projecting the first and second patterns on the photosensitive substrate exhibit opposite trends between the first and second patterns.

8. An exposure method as set forth in claim 8, wherein the phase shift pattern includes one of any of a spatial frequency modulation type, an edge enhancement type, and a halftone type.

9. An exposure method as set forth in claim 8, wherein:
the first and second patterns are projected by an illumination beam through a projection system on to the photosensitive substrate and
the phase shift pattern is transferred on the photosensitive substrate by illumination by modified illumination having an illumination beam region on a pupil plane of the projection system not including an optical axis of the projection system.

10. An exposure method as set forth in claim 9, wherein:
the different illumination conditions include an ordinary illumination condition having an illumination beam region on a pupil plane of the projection system including an optical axis of the projection system and a modified illumination condition having an illumination beam region on the pupil plane of the projection system not including the optical axis of the projection system.

11. An exposure method as set forth in claim 14, wherein the first pattern is illuminated under the ordinary illumination condition and the second pattern is illuminated under the modified illumination condition.

12. An exposure method as set forth in claim 15, wherein the second pattern is a dense pattern partially overlaid with the first pattern.

13. An exposure method as set forth in claim 10, wherein the amounts of exposure are determined in accordance with line widths of the first pattern and the second pattern.

14. An exposure method as set forth in claim 9, wherein the different illumination conditions include a first modified illumination condition having an illumination beam region on a pupil plane of the projection system not including an optical axis of the projection system and illuminating a first region on the pupil plane and a second modified illumination condition having an illumination beam region on the pupil plane of the projection system not including the optical axis of the projection system and illuminating a second region on the pupil plane different from the first region.

15. An exposure method as set forth in claim 18, wherein the first pattern is illuminated under the first modified illumination condition and the second pattern is illuminated under the second modified illumination condition.

16. An exposure method as set forth in claim 19, wherein the first pattern includes an isolated pattern having the same shape as the device pattern and an auxiliary pattern provided at the periphery of the isolated pattern.

17. An exposure method as set forth in claim 18, wherein:
the modified illumination condition includes an annular illumination condition and
the first modified illumination condition and the second modified illumination condition differ in at least one of an annular ratio and annular width of the annular illumination.

18. An exposure method as set forth in claim 1, wherein:
the first pattern is a pattern of substantially the same shape as the device pattern and
the second pattern is a pattern to be partially overlaid with the first pattern.

19. An exposure method as set forth in claim 1, wherein the first pattern and the second pattern are formed on different masks.

20. An exposure method as set forth in claim 1, wherein the first pattern and the second pattern are formed on the same mask.

21. A method for manufacturing a device comprising transferring a device pattern on a workpiece using an exposure method as set forth in claim 1.

22. An exposure apparatus as set forth in claim 4, wherein the second pattern includes a pattern not present in the device pattern.

23. An exposure apparatus as set forth in claim 4, wherein at least one of the first pattern and the second pattern is a phase shift pattern.

24. An exposure apparatus as set forth in claim 4, wherein:
the first pattern and the second pattern are transferred by an illumination beam through a projection system on the photosensitive substrate and
the first pattern and second pattern are transferred on the photosensitive substrate under different illumination conditions.

25. An exposure apparatus as set forth in claim 4, wherein an amount of exposure at the time of transfer of the first pattern and an amount of exposure at the time of transfer of the second pattern are different.

26. An exposure apparatus as set forth in claim 4, wherein the changes in line widths of pattern images in accordance with positions in the direction of an optical axis of the projection system when projecting the first and second patterns on the photosensitive substrate exhibit opposite trends between the first and second patterns.
